(19) United States
(12) Patent Application Publication
(10) Pub. No.: US 2025/0118847 A1
(43) Pub. Date: Apr. 10, 2025

(54) VEHICLE AND BATTERY PACK

(71) Applicant: TOYOTA JIDOSHA KABUSHIKI KAISHA, Toyota-shi (JP)

(72) Inventors: Koji NAGAI, Nagoya-shi (JP); Shigeyuki MORI, Toyota-shi (JP); Naofumi NOMURA, Nagakute-shi (JP); Takuma KOMATSU, Toyota-shi (JP); Yusuke IIDA, Toyota-shi (JP)

(73) Assignee: TOYOTA JIDOSHA KABUSHIKI KAISHA, Toyota-shi (JP)

(21) Appl. No.: 18/776,482

(22) Filed: Jul. 18, 2024

(30) Foreign Application Priority Data
Oct. 5, 2023 (JP) 2023-173531

(51) Int. Cl. H01M 50/244; H01M 10/658; H01M 50/233; H01M 50/249; H01M 50/262

(52) U.S. Cl. CPC H01M 50/244; H01M 10/658; H01M 50/233; H01M 50/249; H01M 50/262; H01M 2220/20

(57) ABSTRACT

The vehicle includes a vehicle body including an underbody, and a battery pack attached to the vehicle body below the underbody. The battery pack includes an upper surface portion provided to face the underbody, and a heat insulating material (mounting member) attached to the upper surface portion. The upper surface portion is provided with a projecting portion protruding toward the underbody side. The heat insulating material is formed with a hole portion into which the projecting portion is inserted. The shortest distance between the projecting portion and the underbody is less than the minimum value of the thickness of the insulation.

### CROSS-REFERENCE TO RELATED APPLICATION

This application claims priority to Japanese Patent Application No. 2023-173531 filed on Oct. 5, 2023, incorporated herein by reference in its entirety.

### BACKGROUND

### 1. Technical Field

The present disclosure relates to a vehicle and a battery pack.

### 2. Description of Related Art

Japanese Unexamined Patent Application Publication No. 2019-046748 (JP 2019-046748 A) discloses a battery pack attached to a vehicle body frame from the bottom side of a vehicle. Members such as a heat conductive member, a heat sink, and a heat insulating sheet are attached to the battery pack.

### SUMMARY

When an external force is applied to the battery pack described in JP 2019-046748 A or the like, a heat conductive member, a heat sink, or a member (mounting member) such as a heat insulating sheet may fall off from the vehicle. The external force is a vibration load, an impact load, a chemical attachment, or the like.

The present disclosure has been made in order to address the above issue, and an object thereof is to provide a vehicle and a battery pack capable of suppressing a mounting member attached to the battery pack falling off from the vehicle.

A first aspect of the present disclosure provides a vehicle including:
a vehicle body that includes an underbody; and
a battery pack attached below the underbody.
The battery pack includes
an upper surface portion provided so as to face the underbody, and
a mounting member attached to the upper surface portion.
The upper surface portion is provided with a projecting portion that projects toward the underbody.
The mounting member is formed with a hole portion into which the projecting portion is inserted.
A shortest distance between the projecting portion and the underbody is less than a minimum value of a thickness of the mounting member.

In the vehicle according to the first aspect of the present disclosure, as described above, the shortest distance between the projecting portion and the underbody is less than the minimum value of the thickness of the mounting member. Accordingly, it is possible to suppress the mounting member from passing through the gap between the projecting portion and the underbody corresponding to the shortest distance. As a result, it is possible to suppress the mounting member attached to the battery pack falling off from the vehicle.

The vehicle according to the first aspect preferably further includes:
an engine; and
an exhaust pipe through which a gas discharged from the engine is discharged.
The exhaust pipe is disposed below the underbody.
The mounting member is a heat insulating material.
With this configuration, it is possible to suppress the radiation heat from the exhaust pipe being transmitted to the battery pack using the mounting member (heat insulating material). Thus, suppressing the mounting member falling off is effective in suppressing the temperature rise of the battery pack due to the radiant heat (components in the battery pack exceeding the allowable temperature due to the radiant heat).

In this case, preferably,
the mounting member is disposed in front of a center of the battery pack in a front-rear direction of the vehicle body.
Here, the engine compartment of the vehicle is generally disposed on the front side of the vehicle body. Thus, the front portion of the battery pack is relatively close to the engine compartment, and thus is susceptible to air warmed by the engine. Thus, the mounting member (heat insulating material) being disposed on the front side of the battery pack is effective in suppressing the temperature rise of the battery pack due to the air warmed by the engine (components in the battery pack exceeding the allowable temperature).

In the vehicle according to the first aspect, preferably,
the projecting portion is spaced apart from the underbody.
Accordingly, it is possible to suppress vibration of the vehicle body being transmitted to the battery pack through the projecting portion. Thus, it is possible to suppress the battery pack being damaged and falling off from the vehicle body due to the vibration of the vehicle body while suppressing the mounting member falling off from the vehicle (battery pack).

A second aspect of the present disclosure provides a battery pack attached to a vehicle, including:
a battery module;
a housing portion that houses the battery module and that includes an upper surface portion; and
a mounting member attached to the upper surface portion.
The upper surface portion is provided so as to face an underbody of the vehicle in a state in which the housing portion is attached to the vehicle.
The upper surface portion is provided with a projecting portion that projects toward the underbody in the state in which the housing portion is attached to the vehicle.
The mounting member is formed with a hole portion into which the projecting portion is inserted.
A shortest distance between the projecting portion and the underbody is less than a minimum value of a thickness of the mounting member in the state in which the housing portion is attached to the vehicle.

In the battery pack according to the second aspect of the present disclosure, as described above, the shortest distance between the projecting portion and the underbody is less than the minimum value of the thickness of the mounting member. Accordingly, it is possible to provide a battery pack capable of suppressing the mounting member attached to the battery pack falling off from the vehicle.

According to the present disclosure, it is possible to suppress the mounting member attached to the battery pack falling off from the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view illustrating a configuration of a vehicle according to an embodiment;

FIG. 2 is a bottom plan view of a vehicle according to one embodiment;

FIG. 3 is a cross-sectional view illustrating an internal configuration of a battery pack according to an embodiment;

FIG. 4 is a top plan view of a battery pack according to an embodiment;

FIG. 5 is a cross-sectional view taken along V-V line of FIG. 4;

FIG. 6 is a cross-sectional view taken along VI-VI line of FIG. 4;

FIG. 7 is a partially enlarged view of the vicinity of a portion where the distance between the projecting portion and the underbody is shortest in FIG. 6; and

FIG. 8 is a diagram illustrating a heat insulating material and a projecting portion according to a modification of the embodiment.

### DETAILED DESCRIPTION OF EMBODIMENTS

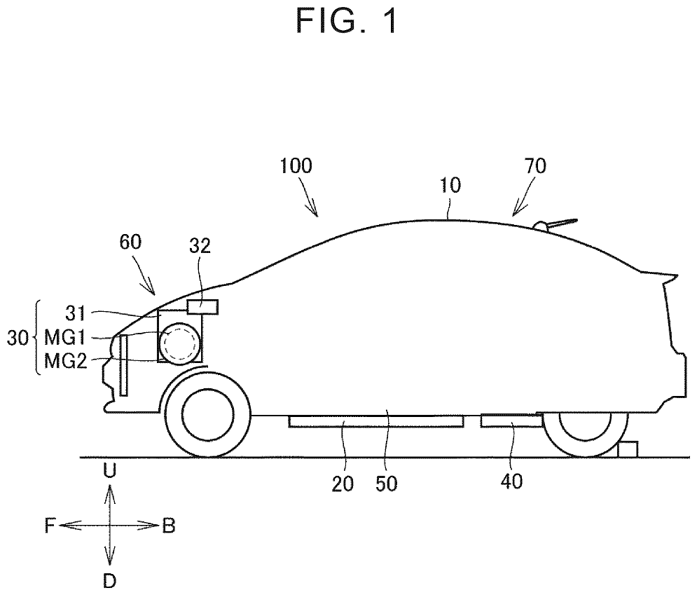

A vehicle and a battery pack according to the present embodiment will be described with reference to FIGS. 1 to 7. Among the configurations illustrated in FIGS. 1 to 7, the same or substantially the same components are denoted by the same reference numerals, and redundant description thereof will be omitted. In FIG. 1 and the like, “U” indicates an upward direction, “D” indicates a downward direction, “L” indicates a left direction, and “R” indicates a right direction.

FIG. 1 is a schematic diagram schematically showing a vehicle 100 on which a battery pack 20 according to the present embodiment is mounted. The vehicle 100 includes a vehicle body 10, a battery pack 20, a drive device 30, and a fuel tank 40. The vehicle 100 is, for example, PHEV (Plug-in Hybrid Electric Vehicle). The vehicle body 10 includes an underbody 50. The underbody 50 is provided at a lower portion (bottom portion) of the vehicle body 10.

An engine compartment 60 and a vehicle cabin 70 are formed in the vehicle body 10. The engine compartment 60 is formed in front of the vehicle cabin 70. The engine compartment 60 is a vehicle body space in which an engine 31 to be described later is mounted. The vehicle cabin 70 is, for example, a space in which a passenger rides.

The drive device 30 includes an engine 31, a rotary electric machine MG1, a rotary electric machine MG2, and a PCU 32. PCU 32 includes, for example, two inverters and converters. One inverter is electrically connected to the rotary electric machine MG1, and the other inverter is connected to the rotary electric machine MG2. The converter is electrically connected to the battery pack 20. The rotary electric machine MG2 mainly functions as a motor for rotating the drive wheels, and the rotary electric machine MG1 mainly functions as a generator. The engine 31 is driven by the fuel supplied from the fuel tank 40, and generates a driving force for rotating the driving wheels.

Each of the battery pack 20 and the fuel tank 40 is attached to the vehicle body 10 (the underbody 50) below the underbody 50. The fuel tank 40 is disposed on the rear side of the battery pack 20.

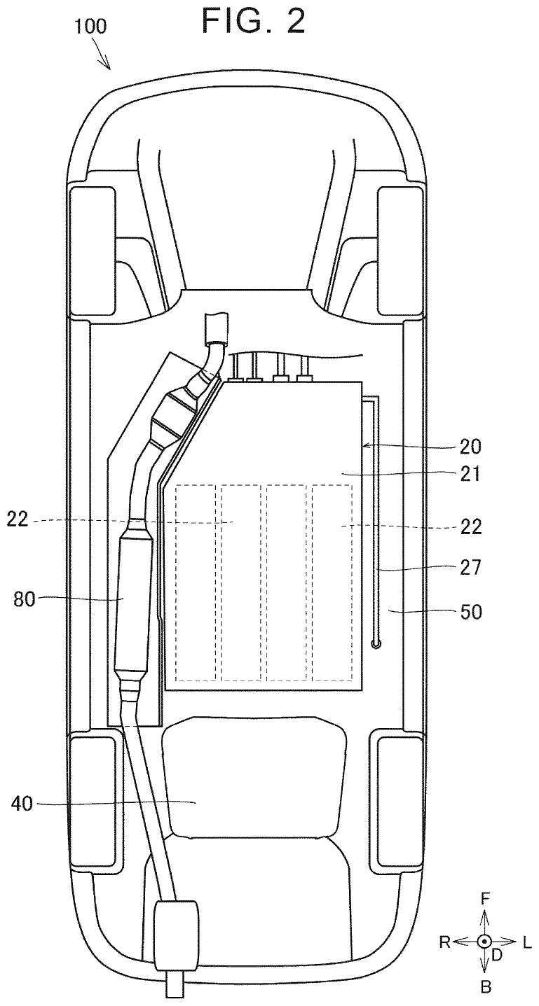

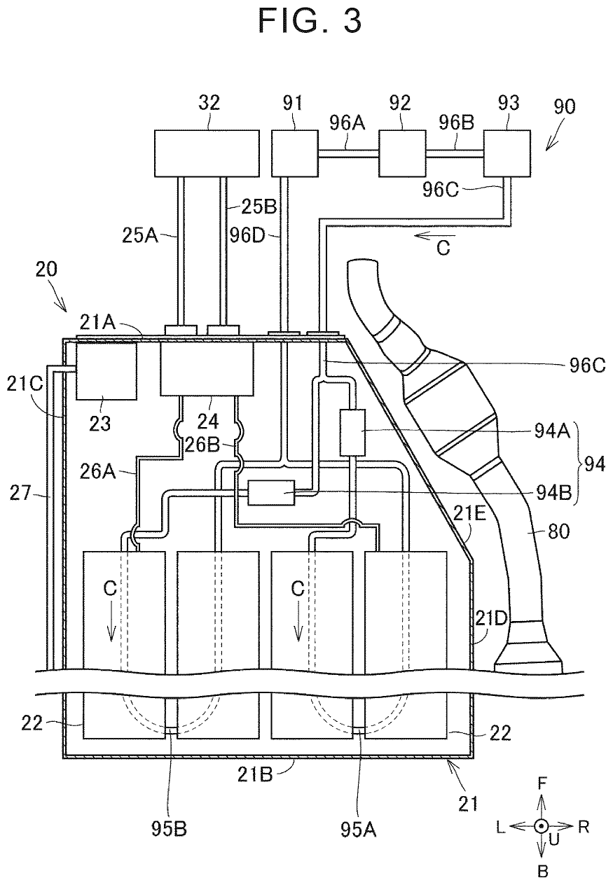

FIG. 2 is a bottom view illustrating a bottom surface of the vehicle 100, and 15 FIG. 3 is a plan view (cross-sectional view) schematically illustrating a configuration of the battery pack 20 and its surroundings. FIG. 3 is a plan view when the battery pack 20 is viewed from the upper side.

The battery pack 20 includes a housing case 21, a plurality of (four in the present embodiment) power storage modules 22, a battery ECU 23 (see FIG. 3), and a junction box 24 (see FIG. 3). The housing case 21 houses the plurality of power storage modules 22, the battery ECU 23, and the junction box 24. Note that the housing case 21 and the power storage module 22 are examples of the “housing portion” and the “battery module” of the present disclosure, respectively.

As shown in FIG. 3, the housing case 21 includes a front end face 21A, a rear end face 21B, a side surface 21C, a side surface 21D, and an inclined side surface 21E. In the embodiment illustrated in FIG. 3, the side surface 21C is located on the left side. The side surface 21D and the inclined side surface 21E are located on the opposite side to the side surface 21C, and the side surface 21D and the inclined side surface 21E are located on the right side. Incidentally, the inclined side surface 21E is connected to the distal end portion 30 of the side surface 21D, and the inclined side surface 21E is inclined so as to approach the side surface 21C toward the front.

The four power storage modules 22 are provided at intervals in the width direction (left-right direction) of the vehicle 100. Each power storage module 22 is electrically connected in series with each other.

Note that each power storage module 22 includes a plurality of power storage cells. The plurality of power storage cells of each power storage module 22 are arranged in the front-rear direction of the vehicle 100. Each power storage cell is, for example, a secondary battery such as a lithium-ion battery or a capacitor.

Each of the battery ECU 23 and the junction box 24 is provided in front of the power storage module 22.

A high-voltage wire 25A, 25B and a high-voltage wire 26A, 26B are connected to the junction box 24. The high-voltage wire 25A, 25B electrically connects the junction box 24 and PCU 32. The high-voltage wire 26A, 26B electrically connects the junction box 24 and the power storage module 22. A relay is provided in the junction box 24. The junction box 24 switches the electric connections of the high-voltage wire 25A, 25B and the high-voltage wire 26A, 26B.

A signal wiring 27 including a signal line and the like is connected to the battery ECU 23, and the signal wiring 27 electrically connects the battery ECU 23 and a ECU (not shown) of the vehicle 100.

The vehicle 100 includes an exhaust pipe 80 and a cooling circuit 90. The exhaust pipe 80 is connected to the engine 31 (see FIG. 1). The exhaust pipe 80 exhausts the gas exhausted from the engine 31. The exhaust pipe 80 is disposed below the underbody 50. The exhaust pipe 80 is formed so as to pass below the underbody 50 and extend rearward from the engine 31. The exhaust pipe 80 is provided along the side surface 21D and the inclined side surface 21E of the battery pack 20.

The cooling circuit 90 includes a compressor 91, a condenser 92, a receiver tank 93, an expansion valve 94 (94A, 94B), a cooling pipe 95A, 95B, and a plurality of refrigerant pipes 96A, 96B, 96C, 96D. The refrigerant circulates in the cooling circuit 90. The refrigerant flows in the flow direction C.

A refrigerant pipe 96C and a cooling pipe 95A are connected to the expansion valve 94A. The refrigerant pipe 96C is connected to the receiver tank 93. A refrigerant pipe 96C and a cooling pipe 95B are connected to the expansion valve 94B. Each of the expansion valve 94A and 94B is accommodated in the housing case 21.

The cooling pipe 95A, 95B is disposed on the lower surface of the power storage module 22, and cools the power storage module 22. In the flow direction C, the downstream end of the cooling pipe 95A, 95B is connected to the refrigerant pipe 96D. The refrigerant pipe 96D is connected to a compressor 91 provided outside the battery pack 20.

Each of the refrigerant pipe 96C and the refrigerant pipe 96D is drawn out of the housing case 21 from the inside of the housing case 21. Each of the refrigerant pipe 96C and the refrigerant pipe 96D is drawn out from the front end face 21A of the housing case 21.

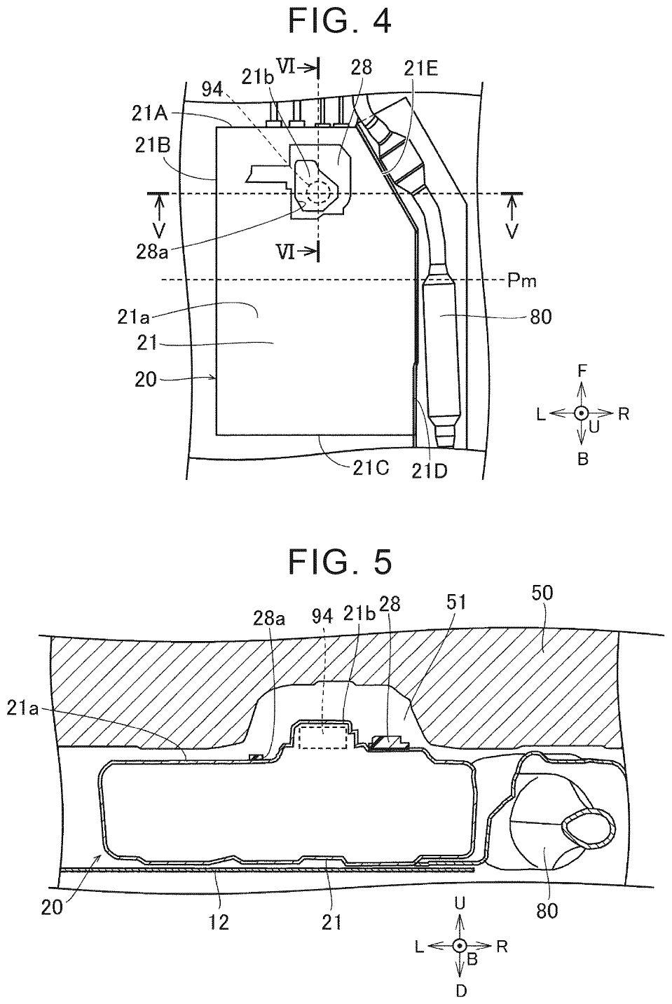

FIG. 4 is a plan view of the battery pack 20 viewed from above. The battery pack 20 (housing case 21) includes an upper surface portion 21a. The upper surface portion 21a is a surface arranged to face upward. The upper surface portion 21a is provided so as to face the underbody 50 (see FIG. 1) with the battery pack 20 (housing case 21) attached to the vehicle 100.

The battery pack 20 includes a heat insulating material 28. The heat insulating material 28 is attached to the upper surface portion 21a. Specifically, the heat insulating material 28 is attached to the upper surface portion 21a by an adhesive material or a double-sided tape. The heat insulating material 28 is formed in a sheet shape. Note that the heat insulating material 28 is an example of the “mounting member” of the present disclosure.

The upper surface portion 21a is provided with a projecting portion 21b. The projecting portion 21b protrudes toward the underbody 50 (upward side) with the battery pack 20 (housing case 21) attached to the vehicle 100.

A hole portion 28a is formed in the heat insulating material 28. A projecting portion 21b of the upper surface portion 21a is inserted into the hole portion 28a. Specifically, the projecting portion 21b penetrates through the hole portion 28a and protrudes toward the underbody 50 from the heat insulating material 28.

The heat insulating material 28 is provided so as to surround the projecting portion 21b. Specifically, the heat insulating material 28 is not formed with a part (notch) that is separated from the heat insulating material, and has a ring-shaped shape that surrounds the projecting portion 21b over the entire circumference. Note that the hole portion 28a is formed in the vicinity of the center of the heat insulating material 28 in a plan view.

An expansion valve 94 is disposed in an inner space of the housing case 21 corresponding to the projecting portion 21b. Both the expansion valve 94A and 94B may be disposed in the inner space, or either one of the expansion valve 94A and 94B may be disposed in the inner space. In FIG. 4 and later, the expansion valve 94A and 94B are referred to as an expansion valve 94 without being distinguished from each other.

FIG. 5 is a cross-sectional view taken along V-V line of FIG. 4. As shown in FIG. 5, an air guide portion 51 is formed between the projecting portion 21b and the underbody 50. The air warmed by the engine 31 (see FIG. 1) passes through the air guide portion 51 and flows to the rear side of the vehicle 100.

The vehicle 100 (the vehicle body 10) includes an under cover 12 disposed below the battery pack 20 (the housing case 21).

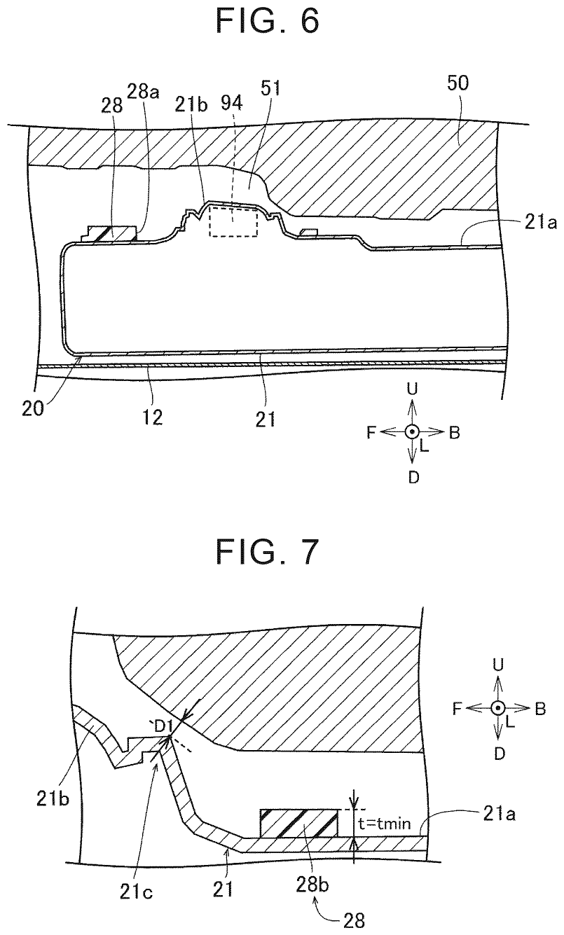

FIG. 6 is a cross-sectional view taken along VI-VI line of FIG. 5. As shown in FIGS. 5 and 6, the projecting portion 21b is spaced apart from the underbody 50. In other words, the projecting portion 21b is provided in the battery pack 20 in a non-contact manner with the underbody 50. Accordingly, even when the battery pack 20 is lifted upward due to interference with a falling object or the like from the vehicle 100, it is possible to suppress the reaction force from the underbody 50 from being transmitted to the battery pack 20. The heat insulating material 28 is also separated from the underbody 50.

Here, in a conventional vehicle, in a case where an external force (vibration load, impact load, chemical adhesion, and the like) is applied to the battery pack, a member such as a heat insulating material may fall off from the vehicle.

Therefore, in the present embodiment, as shown in FIG. 7, the shortest distance D1 between the projecting portion 21b and the underbody 50 is smaller than the minimum value tmin of the thickness t of the heat insulating material 28. Since the projecting portion 21b and the underbody 50 are separated from each other as described above, the shortest distance D1 is larger than 0.

Further, in the embodiment illustrated in FIG. 7, the portion 21c of the projecting portion 21b corresponding to the shortest distance D1 and the partial 28b of the heat insulating material 28 corresponding to the smallest value tmin are arranged side by side in the front-rear direction of the vehicle 100.

Referring back to FIG. 4, the heat insulating material 28 is disposed forward of the center Pm of the battery pack 20 in the front-rear direction of the vehicle body 10 (the vehicle body 10). In other words, the heat insulating material 28 is disposed closer to the engine 31 (see FIG. 1) than the center Pm of the battery pack 20.

Specifically, the heat insulating material 28 is disposed at a position between the side surface 21C and the inclined side surface 21E in the left-right direction of the vehicle 100. Incidentally, the inclined side surface 21E is provided on the front side with respect to the center Pm.

As described above, in the present embodiment, the shortest distance D1 between the projecting portion 21b and the underbody 50 is smaller than the minimum tmin of the thickness t of the heat insulating material 28. As a result, even in the partial 28b of the heat insulating material 28 corresponding to the minimum value tmin, it becomes impossible to pass through the gap between the projecting portion 21b (portion 21c) corresponding to the shortest distance D1 and the underbody 50. Consequently, it is possible to suppress the projecting portion 21b from coming out of the hole portion 28a. Accordingly, it is possible to suppress the heat insulating material 28 from falling off from the vehicle 100 (the battery pack 20).

In the above embodiment, the heat insulating material 28 is attached to the battery pack 20, but the present disclosure is not limited thereto. Instead of the heat insulating material 28, another member (for example, a buffer material or the like) may be attached to the battery pack 20.

In the above embodiment, the heat insulating material 28 is disposed in front of the center Pm of the battery pack 20 in the front-rear direction of the vehicle 100, but the present disclosure is not limited thereto. The heat insulating material 28 may be disposed rearward of the center Pm of the battery pack 20 in the front-rear direction.

In the above embodiment, the projecting portion 21b is separated from the underbody 50, but the present disclosure is not limited thereto. The projecting portion 21b may be in contact with the underbody 50.

In the above-described embodiment, the expansion valve 94 is disposed in the space in the battery pack 20 corresponding to the projecting portion 21b. A member other than the expansion valve 94 may be disposed in the space, or none of the members may be disposed. Further, a projecting portion may be formed by fixing a predetermined member to the upper surface portion 21a.

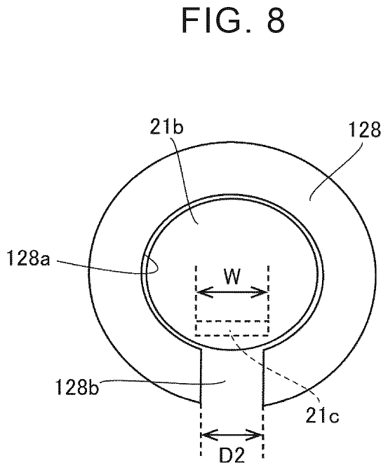

In the above embodiment, the heat insulating material 28 has been shown to surround the entire circumference of the projecting portion 21b, the present disclosure is not limited thereto. The heat insulating material may not surround the entire circumference of the projecting portion 21b. In the embodiment illustrated in FIG. 8, the heat insulating material 128 is formed with a hole portion 128a into which the projecting portion 21b is inserted and a gap portion 128b. The gap portion 128b is formed continuously with the hole portion 128a and extends from the hole portion 128a toward the outer periphery. A notch is formed in the heat insulating material 128 by the gap portion 128b. Further, as described above, the projecting portion 21b is provided with a portion 21c corresponding to the shortest distance D1 (see FIG. 7). The shortest distance D2 (the shortest distance along the circumferential direction of the heat insulating material 128) between the portions of the heat insulating material 128 corresponding to the gap portion 128b is smaller than the smallest width W of the portion 21c. Note that the smallest width W means the smallest width in the direction along the circumferential direction of the projecting portion 21b (heat insulating material 128). Accordingly, it is possible to suppress the heat insulating material 128 from falling off from the vehicles (battery packs) due to the projecting portion 21b passing through the gap portion 128b. Note that the heat insulating material 128 is an example of the “mounting member” of the present disclosure.

It should be considered that the embodiment described herein is just an example in all respects and is not limitative. It is intended that the scope of the disclosure be defined by the appended claims and that all changes within the meaning and range of equivalency of the claims be embraced therein.

What is claimed is:

1. A vehicle comprising:
a vehicle body that includes an underbody; and
a battery pack attached to the vehicle body below the underbody, wherein:
the battery pack includes
an upper surface portion provided so as to face the underbody, and
a mounting member attached to the upper surface portion;
the upper surface portion is provided with a projecting portion that projects toward the underbody;
the mounting member is formed with a hole portion into which the projecting portion is inserted; and
a shortest distance between the projecting portion and the underbody is less than a minimum value of a thickness of the mounting member.

2. The vehicle according to claim 1, further comprising:
an engine; and
an exhaust pipe through which a gas discharged from the engine is discharged, wherein:
the exhaust pipe is disposed below the underbody; and
the mounting member is a heat insulating material.

3. The vehicle according to claim 2, wherein the mounting member is disposed in front of a center of the battery pack in a front-rear direction of the vehicle body.

4. The vehicle according to claim 1, wherein the projecting portion is spaced apart from the underbody.

5. A battery pack attached to a vehicle, comprising:
a battery module;
a housing portion that houses the battery module and that includes an upper surface portion; and
a mounting member attached to the upper surface portion, wherein:
the upper surface portion is provided so as to face an underbody of the vehicle in a state in which the housing portion is attached to the vehicle;
the upper surface portion is provided with a projecting portion that projects toward the underbody in the state in which the housing portion is attached to the vehicle;
the mounting member is formed with a hole portion into which the projecting portion is inserted; and
a shortest distance between the projecting portion and the underbody is less than a minimum value of a thickness of the mounting member in the state in which the housing portion is attached to the vehicle.
